(19) United States
(12) Patent Application Publication
(10) Pub. No.: US 2026/0284910 A1
(43) Pub. Date: Sep. 24, 2026

(54) COMPOSITE ROBOT ARM SYSTEM AND HYBRID MANUFACTURING METHODS

(71) Applicant: Crate3D, New York City, NY (US)

(72) Inventor: Austen Hartley, New York City, NY (US)

(73) Assignee: Crate3D, New York City, NY (US)

(21) Appl. No.: 19/574,303

(22) Filed: Mar. 21, 2026

Related U.S. Application Data
(60) Provisional application No. 63/776,112, filed on Mar. 22, 2025.

(51) Int. Cl. B25J 18/00; B25J 9/00; B29C 64/30; B33Y 10/00; B33Y 40/00; B33Y 80/00

(52) U.S. Cl. CPC B25J 18/00; B25J 9/0012; B29C 64/30; B33Y 10/00; B33Y 40/00; B33Y 80/00

(57) ABSTRACT

Composite robotic components and hybrid manufacturing methods are disclosed. Additively manufactured polymer structures are combined with prefabricated reinforcement members, such as metal plates or skeletons, to form composite robot arm links, joints, and base assemblies. In one embodiment, a robotic arm component includes first and second polymer shell portions and a reinforcement plate disposed between them, with interlocking features inhibiting relative movement and fasteners securing the assembly. In another embodiment, a robot base includes a polymer shell printed to an intermediate state, a reinforcement skeleton inserted into hollow spaces, and printing resumed to capture the skeleton. The resulting composite structures can reduce cost and lead time while improving strength, stiffness, and manufacturability in robotic systems.

### CROSS-REFERENCE TO RELATED APPLICATIONS

This application claims the benefit of U.S. Provisional Patent Application No. 63/776,112, filed Mar. 22, 2025, entitled “Composite Robot Arm System and Method,” the contents of which are incorporated herein by reference in their entirety.

### FIELD OF THE INVENTION

The present disclosure relates generally to robotic systems and, more particularly, to composite robotic structural components and hybrid manufacturing techniques that combine additive manufacturing with prefabricated reinforcement members to form load-bearing robot arm and base structures.

### BACKGROUND

Robotic systems often require structural components capable of transmitting substantial loads across joints while maintaining alignment, housing actuators and associated hardware, and protecting internal components such as motors, sensors, wiring, and control electronics. Conventional robotic structures frequently rely on machined metal components, castings, and other precision-fabricated parts, which can increase cost, weight, lead time, and manufacturing complexity.

Although additive manufacturing can reduce tooling cost and enable complex geometries, polymer-only structures may lack sufficient strength, stiffness, dimensional stability, and wear resistance in high-load regions such as motor mounts, rotating joints, and base interfaces. There remains a need for robotic component architectures and manufacturing methods that preserve the flexibility and cost advantages of additive manufacturing while incorporating reinforcement members that provide improved structural performance, precision mounting interfaces, and durable load paths.

### SUMMARY

The present disclosure provides composite robotic components and hybrid manufacturing methods in which additively manufactured polymer structures are combined with prefabricated reinforcement members, such as metal plates, frames, and skeletons, to form load-bearing robotic links, joints, and base assemblies.

In some embodiments, a robotic arm component includes a polymer body or shell and a prefabricated reinforcement member coupled to, sandwiched within, or embedded in the polymer body. The reinforcement member may define a primary load path and/or a precision mounting interface for a motor, gearbox, bearing, or other rotary component, while the polymer body may define an exterior geometry, internal routing volume, protective cover, and/or mating features for assembly.

In some embodiments, an arm component assembly includes a first polymer shell portion, a second polymer shell portion, and a reinforcement plate disposed between the shell portions. One or both shell portions may define protrusions or other interlocking features received in corresponding cavities or openings of the reinforcement plate to inhibit relative movement. Fasteners may clamp the shell portions and reinforcement plate together to form a composite structural member.

In some embodiments, a robotic base assembly includes an additively manufactured shell and a prefabricated reinforcement skeleton disposed within one or more hollow spaces of the shell. The shell may be printed to an intermediate build state that leaves the hollow spaces accessible, the reinforcement skeleton may be inserted while printing is paused, and printing may then be resumed to complete the shell with the reinforcement skeleton captured within the shell.

In some embodiments, a base cover assembly is coupled to a lower portion of the shell and cooperates with the reinforcement skeleton to secure the reinforcement skeleton relative to the shell. For example, a base cover assembly may include a reinforcement plate having one or more slots configured to receive one or more tabs of the reinforcement skeleton.

In some embodiments, a method of manufacturing a composite robotic component includes additively manufacturing a polymer body portion to an intermediate build state that defines a cavity, hollow space, or accessible region; interrupting or pausing additive manufacturing; inserting a prefabricated reinforcement member into the cavity, hollow space, or accessible region; and completing the polymer body portion such that the reinforcement member is captured within or fixed relative to the resulting composite robotic component.

These and other embodiments can reduce machining and tooling costs, reduce weight, improve manufacturability, shorten lead time, and provide robust structural load paths and mounting interfaces for robotic systems.

### BRIEF DESCRIPTION OF THE DRAWINGS

FIG. 1 illustrates a perspective view of a composite robot arm system in accordance with one embodiment of the present disclosure.

FIG. 2 illustrates a perspective view of a finished intermediary arm component assembly in accordance with one embodiment of the present disclosure.

FIG. 3 illustrates a partially exploded perspective view of the intermediary arm component assembly of FIG. 2, showing a base cover separated from an insertable reinforcement plate.

FIG. 4 illustrates a perspective view of the intermediary arm component assembly showing installation of fasteners relative to the base cover and reinforcement plate.

FIG. 5 illustrates a partially exploded perspective view of the intermediary arm component assembly showing installation of a top cover over the reinforcement plate and base cover.

FIG. 6 illustrates a perspective view of a finished base assembly in accordance with one embodiment of the present disclosure.

FIG. 7 illustrates a perspective view of a partially printed shell for the base assembly, showing outer walls, inner walls, and accessible hollow spaces.

FIG. 8 illustrates a perspective view of an insertable reinforcement skeleton for the base assembly.

FIGS. 9A and 9B illustrate perspective views of insertion of the reinforcement skeleton into the partially printed shell and a resulting assembly state.

FIG. 10 illustrates a perspective view of a finished shell having the reinforcement skeleton captured therein.

FIG. 11 illustrates a perspective view of a base cover assembly.

FIG. 12 illustrates a partially exploded perspective view of installation of the base cover assembly relative to the finished shell.

FIG. 13 illustrates a perspective view of a composite robot arm system including a primary or top arm component assembly, an intermediary arm component assembly, and a base assembly reinforced by a reinforcement skeleton in accordance with one embodiment of the present disclosure.

FIG. 14 illustrates an exploded perspective view of a primary or top arm component assembly including a polymer piece and a reinforcement plate.

FIG. 15 illustrates a perspective view of a composite robot arm system in which polymer covers are installed over arm components and a base assembly.

FIG. 16A illustrates a perspective view of an alternate composite robot arm system embodiment focused primarily on polymer components.

FIG. 16B illustrates a close-up perspective view of a primary or top arm component assembly without polymer cover and showing a reinforcement plate embedded in a polymer structure, along with a rotary or motor component.

FIG. 17 illustrates a process flow for a hybrid assembly and manufacturing method in accordance with one embodiment of the present disclosure.

### DETAILED DESCRIPTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

Unless the context clearly requires otherwise, directional and relational terms such as top, bottom, upper, lower, inner, outer, between, intermediate, and within are used for convenience of description with reference to the illustrated embodiments and do not require a particular orientation in use. The terms “comprise,” “comprising,” “include,” and “including” are open-ended and do not exclude additional elements or steps. Unless expressly stated otherwise, process steps described herein may be performed in different orders, in parallel, or with additional intervening steps.

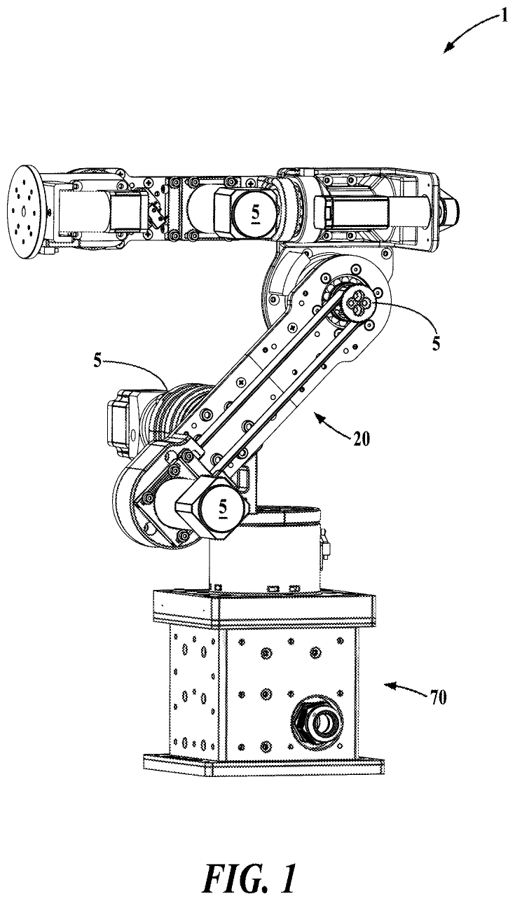

Referring initially to FIG. 1, a composite robot arm system 1 includes one or more rotary or motor components 5, a primary or top arm component or assembly 10, an intermediary, middle, or bottom arm component assembly 20, and a base assembly 70. The composite robot arm system 1 may be any suitable robotic manipulator, articulated arm, or other robotic mechanism in which one or more composite structural components transmit loads between actuated joints. The system 1 may further include gearboxes, bearings, encoders, sensors, controllers, wiring, wiring harnesses, pneumatic lines, cooling lines, end effectors, and other equipment supported by or routed through the components described herein.

The disclosed composite architectures are particularly useful where a polymer component alone would be insufficiently strong or stiff, but where a fully machined metal component would be unnecessarily expensive, heavy, or slow to manufacture. In various embodiments, a prefabricated reinforcement member can provide a principal structural load path, a precision motor or bearing mounting interface, and/or a wear-resistant joint region, while an additively manufactured polymer body provides one or more protective covers, internal routing volumes, exterior contours, assembly features, and low-cost custom geometry.

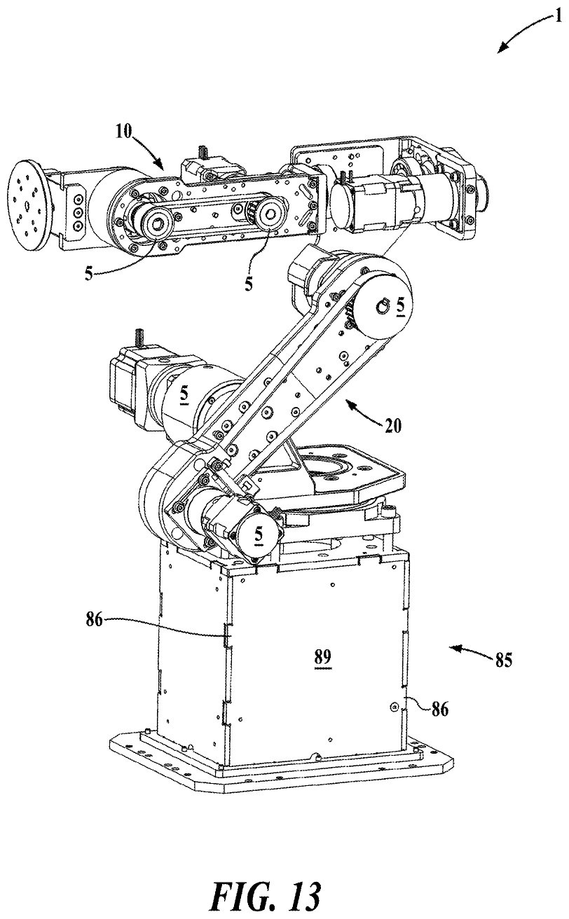

Turning to FIGS. 13, 14, 15, 16A, and 16B, the primary or top arm component assembly 10 can include a polymer piece 15, a prefabricated reinforcement plate 17, and, in some embodiments, a polymer cover 19. As shown, the polymer piece 15 may define securing holes 15a and one or more motor or rotary-component-receiving openings 15b. The reinforcement plate 17 may define securing holes 17a and motor or rotary-component-receiving openings 17b that align with corresponding features of the polymer piece 15. In some embodiments, the reinforcement plate 17 is positioned adjacent the polymer piece 15, is partially embedded in the polymer piece 15, or is captured between multiple polymer parts such that the reinforcement plate 17 provides a rigid load-bearing member and a mounting interface for one or more rotary or motor components 5. The cover 19 may enclose or protect a portion of the assembly 10 while still permitting access to mounting interfaces, rotating shafts, fasteners, or service openings.

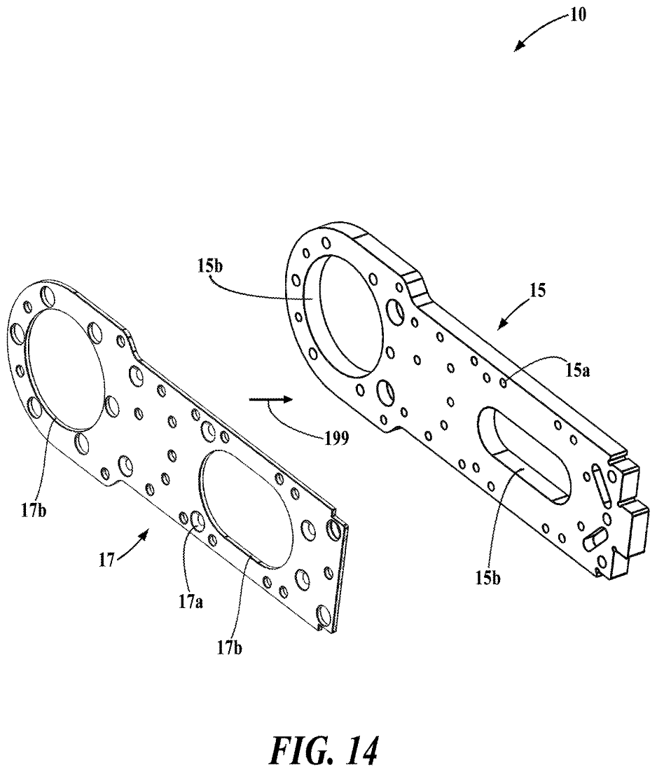

FIG. 14 depicts one representative exploded arrangement of the primary or top arm component assembly 10 in which the reinforcement plate 17 is aligned for installation relative to the polymer piece 15 along installation arrow 199. In some embodiments, the polymer piece 15 and reinforcement plate 17 are secured together by screws, bolts, rivets, threaded inserts, adhesive, welding, interference fit, captured geometry, or any combination thereof. In some embodiments, the reinforcement plate 17 is formed of aluminum, steel, stainless steel, titanium, composite laminate, or another prefabricated structural material. In some embodiments, the polymer piece 15 is additively manufactured, molded, machined, cast, or formed using a hybrid process.

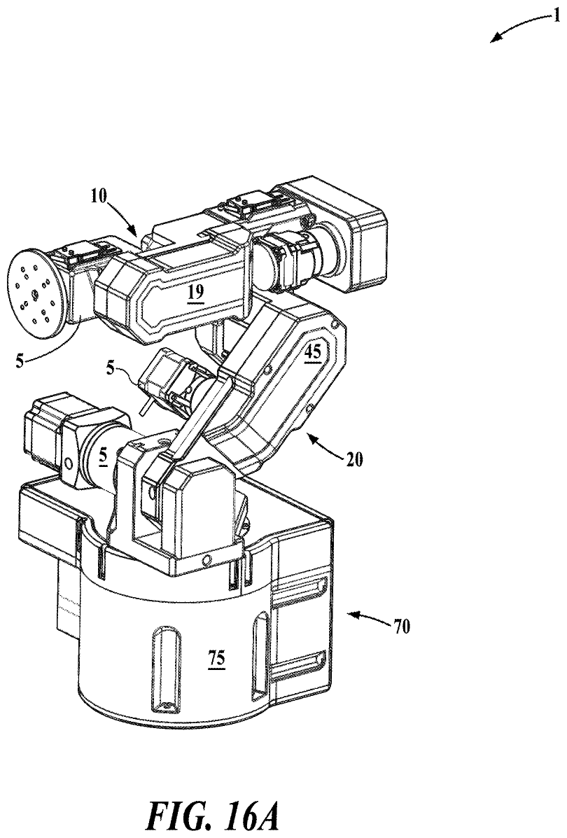

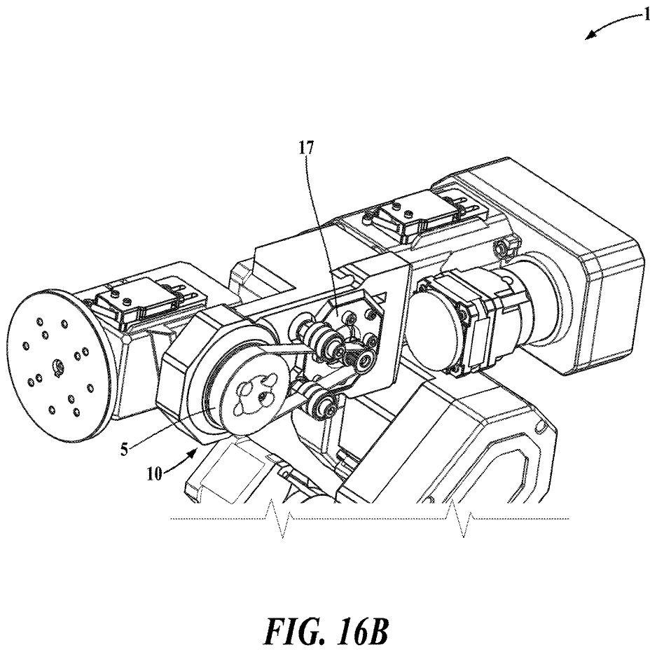

FIG. 16B illustrates that the reinforcement plate 17 may be disposed at a joint region and may receive fasteners or mounting loads from an opposing side of the polymer piece 15 and/or cover 19. In this manner, the reinforcement plate 17 may support a rotary or motor component 5, gearbox, bearing set, or other joint hardware while surrounding polymer material defines external geometry and can transfer loads into the reinforcement plate. Although FIGS. 14 and 16B depict a generally plate-like reinforcement member, other reinforcement member configurations may be used, including frames, brackets, rings, lattices, trusses, ribs, cages, or multi-piece reinforcement subassemblies.

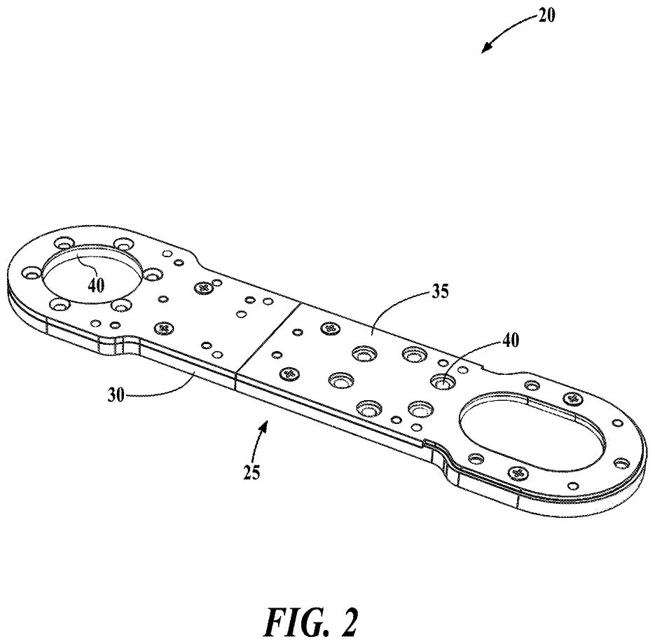

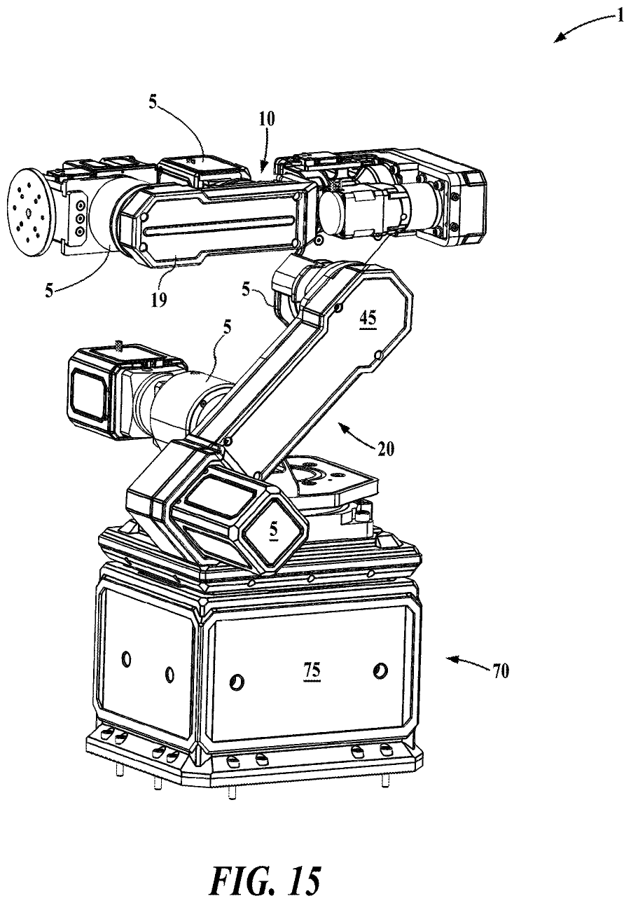

Referring now to FIGS. 2-5, the intermediary arm component assembly 20 is another example of a composite structural member. In the illustrated embodiment, the assembly 20 includes a polymer shell 25, screws or fasteners 20a, a base cover 30, a top cover 35, and a prefabricated insertable reinforcement plate 40. In some embodiments, the shell 25 is defined by the base cover 30 and the top cover 35 together. In some embodiments, an additional polymer cover 45 is provided, as shown for example in FIGS. 15 and 16A, to protect or aesthetically finish an outer region of the intermediary arm component assembly 20.

The shell 25 can be produced by additive manufacturing, such as fused filament fabrication, stereolithography, selective laser sintering, or another three-dimensional printing process. In other embodiments, the shell 25, base cover 30, and/or top cover 35 can be molded, machined, cast, thermoformed, or formed by a different suitable process. The reinforcement plate 40 can be stamped, laser cut, machined, forged, cast, molded, or otherwise prefabricated before assembly with the shell 25.

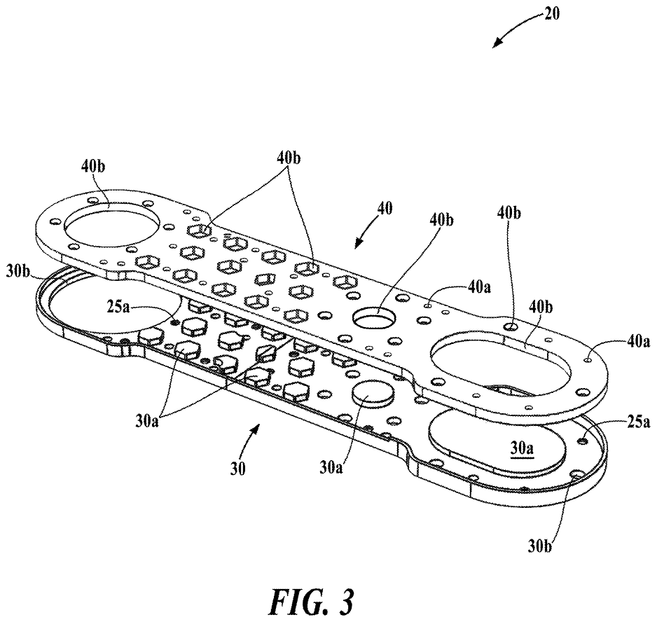

As shown in FIG. 3, the base cover 30 may define bottom protrusions 30a and bottom openings 30b. The shell 25 may define screw holes 25a. The reinforcement plate 40 may define screw holes 40a and receiving cavities 40b positioned to receive the protrusions 30a. The protrusions 30a and receiving cavities 40b can cooperate as an interlocking geometry that inhibits lateral translation, rotation, and/or shear displacement of the reinforcement plate 40 relative to the base cover 30. In some embodiments, one or more protrusions 30a and corresponding cavities 40b are polygonal, hexagonal, ovular, arcuate, keyed, asymmetric, tapered, snap-fit, or interference-fit features.

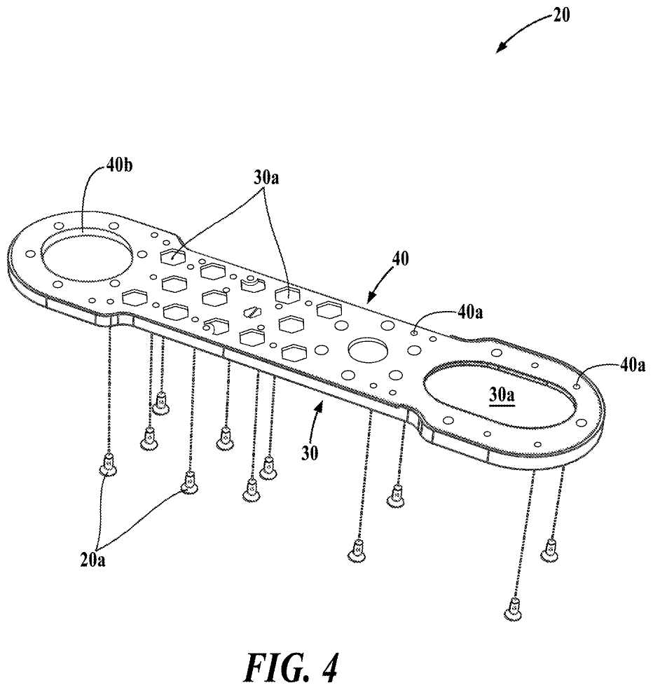

As shown in FIG. 4, the reinforcement plate 40 may be positioned against the base cover 30 such that the protrusions 30a are received in the receiving cavities 40b and holes of the components are aligned. Fasteners 20a may then extend through the aligned holes, including one or more screw holes 25a and screw holes 40a, to secure the base cover 30 and the reinforcement plate 40 relative to one another. In some embodiments, the fasteners 20a are threaded into threaded inserts, threaded bosses, nuts, threaded portions of the reinforcement plate 40, or threaded portions of another structural component.

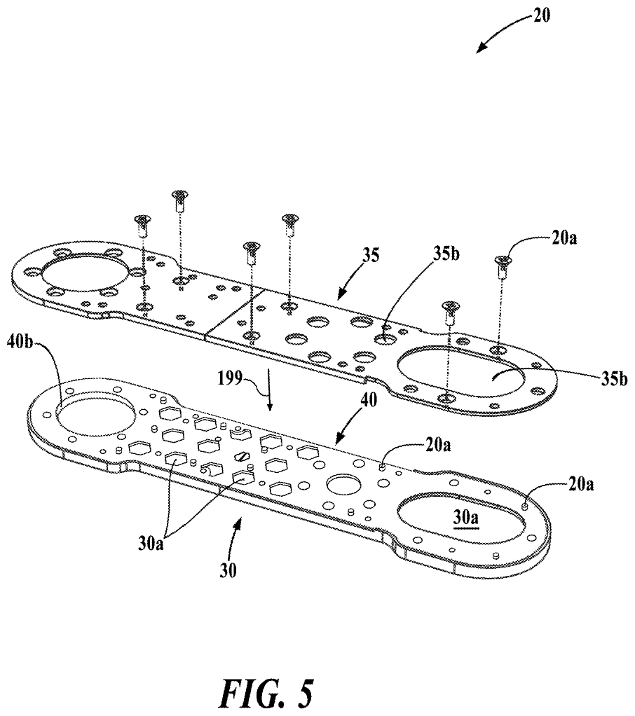

As shown in FIG. 5, the top cover 35 may be installed over the reinforcement plate 40 and the base cover 30 along installation arrow 199. The top cover 35 may define top openings 35b and may optionally define one or more protrusions, complementary recesses, alignment ribs, standoffs, or bosses that cooperate with the reinforcement plate 40 and/or the base cover 30. Once the top cover 35 is positioned, one or more fasteners 20a can clamp the top cover 35, reinforcement plate 40, and base cover 30 together to form the completed intermediary arm component assembly 20. In some embodiments, the reinforcement plate 40 is thus sandwiched between first and second polymer shell portions. In some embodiments, the fasteners 20a remain accessible for service, while in other embodiments one or more fasteners are concealed by a cosmetic or protective cover.

The intermediary arm component assembly 20 can provide a robust and lightweight link structure. In one example, the reinforcement plate 40 is the primary load-bearing member between adjacent rotary or motor components 5, while the shell 25 provides shape, stiffness, cover functions, cable routing, and mounting geometry. In some embodiments, the shell 25 defines channels, cavities, or clearance regions for wiring, tubing, bearings, seals, or sensor hardware. In some embodiments, the reinforcement plate 40 includes large openings to reduce weight while preserving material at high-stress regions. In some embodiments, the shell 25 includes local thickened regions, ribs, gussets, bosses, lattice infill zones, or fiber-reinforced polymer portions to tailor stiffness or printability.

Although FIGS. 2-5 illustrate a reinforcement plate 40 sandwiched between polymer shell portions, other embodiments can partially embed the reinforcement plate 40 within a polymer body, overmold polymer around portions of the reinforcement plate 40, or use multiple reinforcement plates 40 arranged in spaced relation. In some embodiments, a reinforcement member is disposed closer to one side of the polymer body than the other. In some embodiments, the reinforcement member is a multi-part frame, truss, or skeleton rather than a single plate.

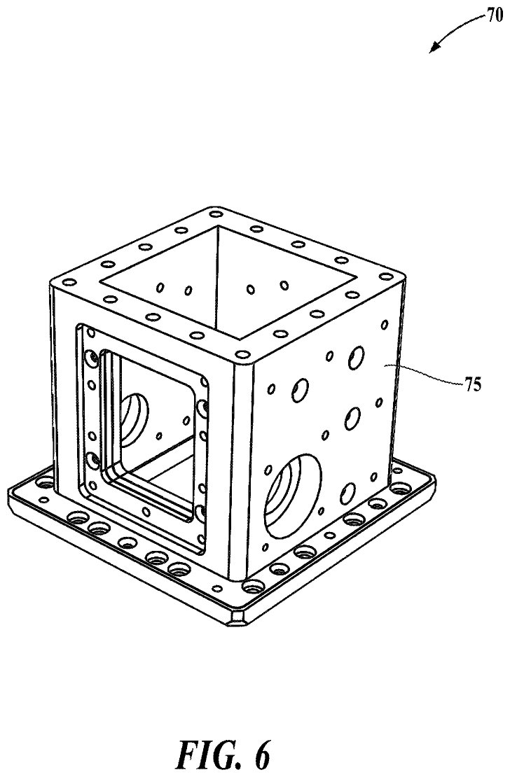

Referring to FIGS. 6-12, the base assembly 70 includes a shell 75, a partially printed shell 75a, an insertable reinforcement skeleton 85, and a base cover assembly 90. The shell 75 can be a fully finished polymer shell, while the partially printed shell 75a represents an intermediate build state of the shell during manufacture. The shell 75 or 75a may define screw holes 76, outer walls 77, inner walls 78, accessible hollow spaces 79, a floor portion 80, and openings 81, including a top opening 81a.

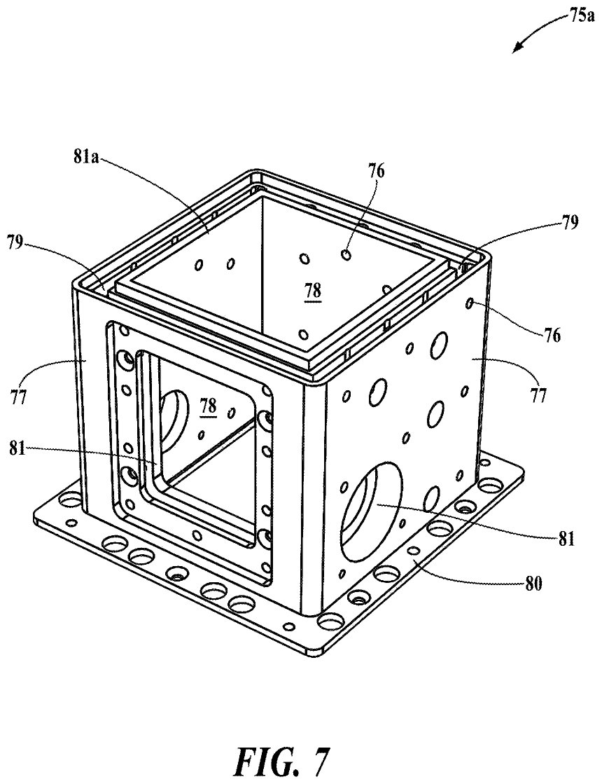

As best illustrated in FIG. 7, the outer walls 77 and inner walls 78 can cooperate to define one or more accessible hollow spaces 79 within the partially printed shell 75a. These hollow spaces 79 can receive a reinforcement member and may also provide space for motors, wiring, power components, controllers, bearings, cable chains, pneumatic hardware, or thermal-management structures. The floor portion 80 can define a mounting flange or support base. The openings 81 can provide access, ventilation, serviceability, or passage of shafts, cables, or components.

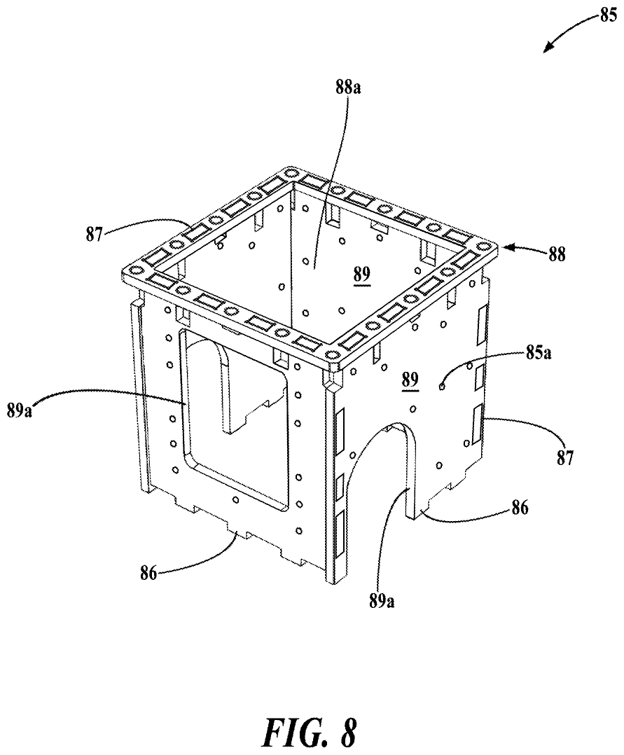

FIG. 8 illustrates one embodiment of the reinforcement skeleton 85. The reinforcement skeleton 85 can include screw holes 85a, tabs 86, slots 87, a unifying top piece 88 having a central opening 88a, and one or more skeleton walls 89 defining openings 89a. In some embodiments, the skeleton walls 89 are assembled to the top piece 88 using the tabs 86 and slots 87 to form a rigid cage-like structure. In some embodiments, the reinforcement skeleton 85 is welded, riveted, adhesively bonded, press-fit, pinned, brazed, or otherwise connected as a unitary or multi-piece structure before or during insertion into the partially printed shell 75a.

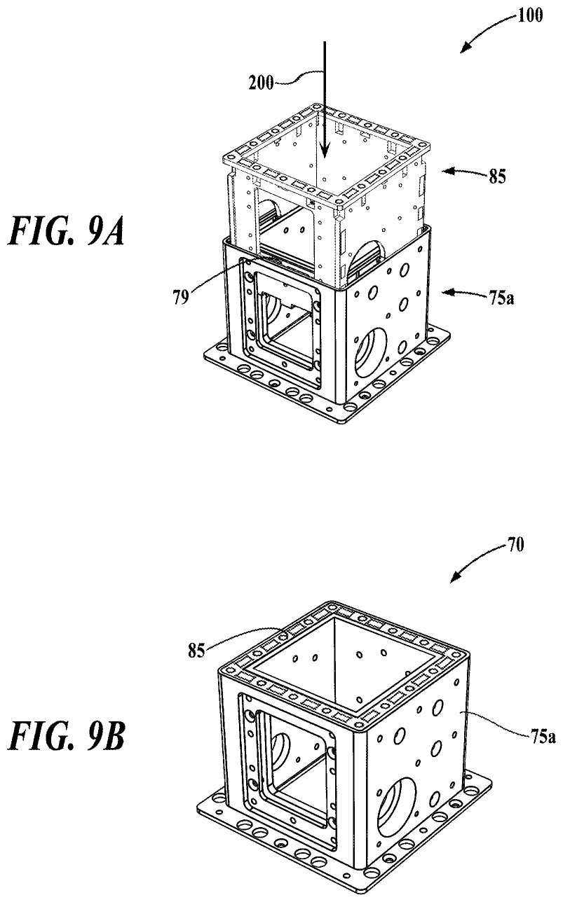

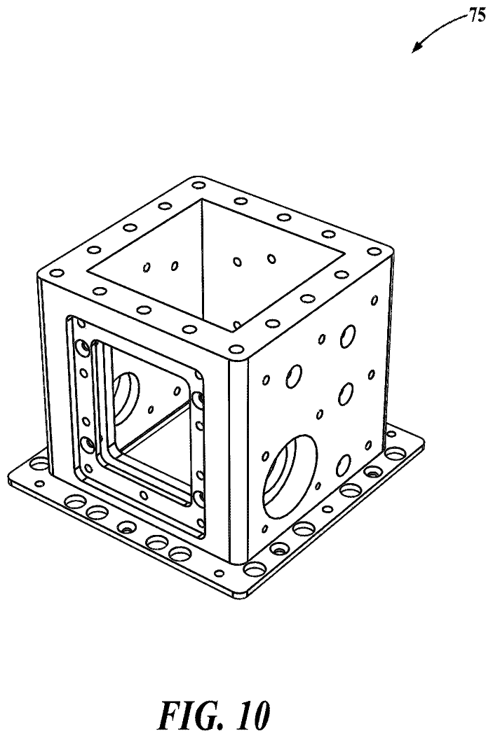

Referring to FIGS. 9A and 9B, the reinforcement skeleton 85 can be inserted into the partially printed shell 75a along installation arrow 200 while the accessible hollow spaces 79 remain open. Once the reinforcement skeleton 85 is placed in position, additive manufacturing of the shell may continue so that additional polymer material encloses or captures portions of the reinforcement skeleton 85, resulting in a completed base assembly 70 or a completed shell 75 with the reinforcement skeleton 85 retained therein. FIG. 10 illustrates a finished shell 75 after capture of the reinforcement skeleton 85.

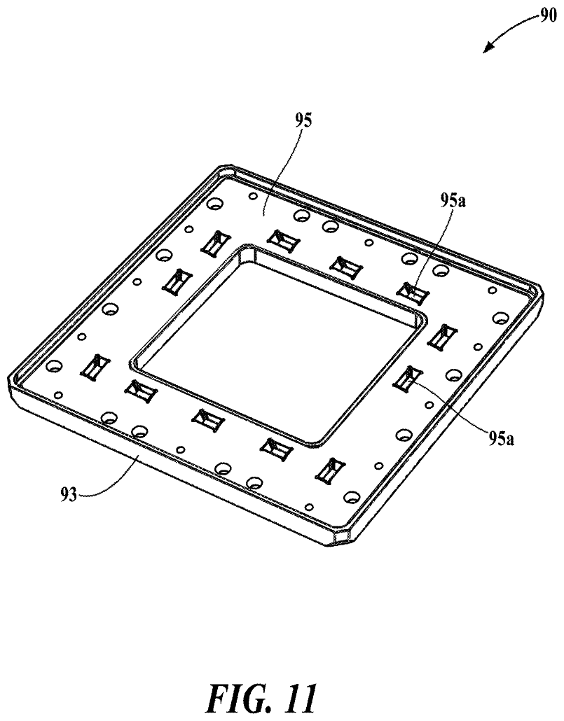

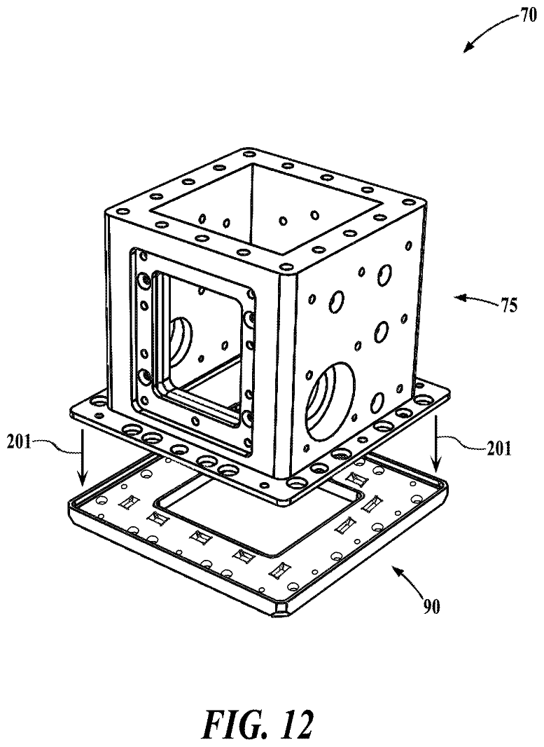

The base cover assembly 90, shown in FIG. 11, may include a base cover 93 and an insertable base reinforcement plate 95 having base plate slots 95a. Referring to FIG. 12, the base cover assembly 90 can be installed relative to the shell 75 along installation arrows 201. In some embodiments, one or more tabs 86 of the reinforcement skeleton 85 extend into or through corresponding base plate slots 95a so that the base reinforcement plate 95 helps retain the reinforcement skeleton 85 relative to the shell 75. The base cover 93 and/or base reinforcement plate 95 may also define mounting interfaces for attachment of the base assembly 70 to a support surface, pedestal, vehicle, tool, or another robotic structure.

The reinforcement skeleton 85 can provide substantial stiffness and load-bearing capacity to the base assembly 70 while the shell 75 provides exterior form, low-cost custom geometry, environmental shielding, and integration features. In some embodiments, the reinforcement skeleton 85 resists torsional loads generated by the arm assemblies 10 and 20. In some embodiments, the reinforcement skeleton 85 transfers loads between a rotating upper structure and a lower mounting surface. In some embodiments, the shell 75 provides service openings, cable-routing passages, mounting bosses, cosmetic surfaces, and/or impact-resistant covers.

FIGS. 13, 15, and 16A further illustrate that the disclosed composite construction principles can be applied across multiple portions of a robotic system. For example, the system 1 can include multiple arm components having polymer covers installed over mechanical elements, multiple composite links, and different base configurations. In some embodiments (for example, the most economic model, depicted in FIGS. 16A and 16B), a system may use a higher proportion of polymer parts while still retaining reinforcement plates or skeletons at high-load interfaces. In some embodiments, the polymer components are removable covers. In some embodiments, the polymer components themselves are structural members. In some embodiments, a composite component can be used at a shoulder joint, elbow joint, wrist joint, end effector support, or other link region.

The reinforcement members disclosed herein may be selected based on the expected load case, manufacturing constraints, and desired weight. For example, an aluminum reinforcement plate may be used for a balance of low weight and stiffness, while a steel reinforcement member may be used where higher strength or wear resistance is desirable. In some embodiments, the polymer material comprises nylon, polycarbonate, ABS, PETG, PEEK, PEKK, Ultem, carbon-fiber-filled polymer, glass-filled polymer, or another engineering polymer. In some embodiments, multiple polymer materials and/or multiple reinforcement materials are used in a single component.

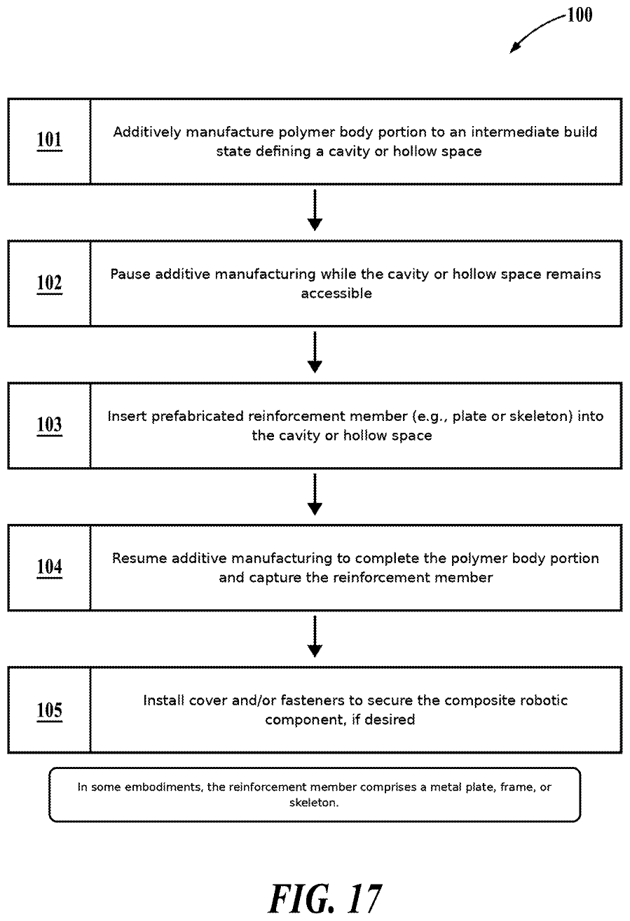

The disclosed hybrid manufacturing method 100 is illustrated in FIG. 17. In step 101, a polymer body portion is additively manufactured to an intermediate build state defining a cavity or hollow space. In step 102, additive manufacturing is paused while the cavity or hollow space remains accessible. In step 103, a prefabricated reinforcement member, such as a plate, frame, or skeleton, is inserted into the cavity or hollow space. In step 104, additive manufacturing is resumed to complete the polymer body portion and capture the reinforcement member. In step 105, a cover and/or one or more fasteners may be installed to secure the resulting composite robotic component, if desired.

In some embodiments, the method 100 is used to form the base assembly 70 by printing the shell 75a to an intermediate state, inserting the reinforcement skeleton 85, and printing additional material to complete the shell 75. In some embodiments, the method 100 is used to form an arm component in which a reinforcement plate is partially embedded in a printed polymer body and later coupled to a motor or bearing assembly from an opposing side. In some embodiments, the reinforcement member is inserted robotically or by a user. In some embodiments, printing is paused automatically at a predetermined layer height based on a machine instruction or sensor input.

The sequence of operations of the method 100 can vary. For example, a reinforcement member may be pre-positioned in a fixture and printing may occur around the reinforcement member; multiple pauses may occur to insert multiple reinforcement members; one or more fasteners may be installed before printing resumes; or the component may be subsequently machined, heat treated, annealed, coated, or otherwise post-processed. Accordingly, the method is not limited to the exact sequence shown in FIG. 17 unless expressly recited in a claim.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted. Features of one embodiment may be combined with features of another embodiment. Dimensions, shapes, and proportions shown in the figures are illustrative and may be varied. Reference numerals are provided for convenience and do not limit claim scope. The figures and embodiments are exemplary and not limiting.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A robotic arm component assembly comprising:
a first polymer body portion;
a second polymer body portion;
a prefabricated reinforcement plate associated with the first polymer body portion and the second polymer body portion and configured to reinforce the robotic arm component assembly;
at least one interlocking feature defined by at least one of the first polymer body portion or the second polymer body portion and configured to cooperate with a corresponding feature of the prefabricated reinforcement plate to inhibit relative movement between the prefabricated reinforcement plate and the at least one of the first polymer body portion or the second polymer body portion; and
at least one fastener securing the first polymer body portion, the second polymer body portion, and the prefabricated reinforcement plate together to form a composite robotic arm component assembly.

2. The robotic arm component assembly of claim 1, wherein the prefabricated reinforcement plate is disposed between the first polymer body portion and the second polymer body portion.

3. The robotic arm component assembly of claim 1, wherein the at least one interlocking feature comprises at least one protrusion received in a corresponding cavity of the prefabricated reinforcement plate.

4. The robotic arm component assembly of claim 3, wherein the at least one protrusion comprises a plurality of protrusions and the corresponding cavity comprises a plurality of cavities.

5. The robotic arm component assembly of claim 1, wherein at least one of the first polymer body portion or the second polymer body portion is additively manufactured.

6. The robotic arm component assembly of claim 1, wherein the prefabricated reinforcement plate comprises a metal plate configured to provide a load-bearing path through the robotic arm component assembly.

7. The robotic arm component assembly of claim 1, wherein the robotic arm component assembly defines an arm link, joint structure, or actuator-support structure of a robotic arm.

8. The robotic arm component assembly of claim 1, wherein at least one of the first polymer body portion or the second polymer body portion defines an internal routing volume for at least one of wiring, tubing, cooling lines, or electronic components.

9. The robotic arm component assembly of claim 1, wherein the first polymer body portion and the second polymer body portion together define an exterior geometry of the robotic arm component assembly and at least partially house an internal component of the robotic arm component assembly.

10. The robotic arm component assembly of claim 1, wherein at least one of the first polymer body portion or the second polymer body portion defines at least one mounting interface for an actuator, sensor, cover, or electronic component supported by the robotic arm component assembly.

11. A method of manufacturing a composite robotic component, the method comprising:
additively manufacturing a polymer body portion to an intermediate build state that defines an accessible cavity or hollow space;
pausing additive manufacturing while the accessible cavity or hollow space remains accessible;
inserting a prefabricated reinforcement member into the accessible cavity or hollow space; and
resuming additive manufacturing of the polymer body portion such that at least a portion of the prefabricated reinforcement member becomes captured within the polymer body portion.

12. The method of claim 11, wherein the prefabricated reinforcement member comprises a plate, frame, or skeleton.

13. The method of claim 11, wherein resuming additive manufacturing comprises enclosing at least a portion of the prefabricated reinforcement member within the polymer body portion.

14. The method of claim 11, further comprising coupling a cover portion to the polymer body portion after insertion of the prefabricated reinforcement member.

15. The method of claim 11, wherein the prefabricated reinforcement member comprises a reinforcement skeleton inserted into the accessible cavity or hollow space of a partially printed base shell.

16. The method of claim 11, further comprising securing the prefabricated reinforcement member relative to the polymer body portion using at least one interlocking feature.

17. A robotic system comprising:
a base assembly comprising:
an additively manufactured shell defining at least one hollow space; and
a prefabricated reinforcement skeleton positioned in the at least one hollow space of the shell; and
a robotic arm coupled to the base assembly,
wherein at least one portion of the shell is additively manufactured after insertion of the prefabricated reinforcement skeleton such that the prefabricated reinforcement skeleton is captured relative to the shell.

18. The robotic system of claim 17, further comprising a base cover assembly coupled to the shell and configured to secure the prefabricated reinforcement skeleton relative to the shell.

19. The robotic system of claim 18, wherein the base cover assembly comprises a reinforcement plate having at least one slot configured to receive at least one tab of the prefabricated reinforcement skeleton.

20. The robotic system of claim 17, wherein the robotic arm comprises a robotic arm component assembly including a first polymer body portion, a second polymer body portion, and a prefabricated reinforcement plate secured therebetween.
